(19) United States
(12) Patent Application Publication
(10) Pub. No.: US 2026/0024313 A1
(43) Pub. Date: Jan. 22, 2026

(54) Method and Device for Optimizing Activation Maps

(71) Applicant: Robert Bosch GmbH, Stuttgart (DE)

(72) Inventor: David Walther Schoenleber, Karlsruhe (DE)

(21) Appl. No.: 19/268,179

(22) Filed: Jul. 14, 2025

(30) Foreign Application Priority Data
Jul. 19, 2024 (DE) 10 2024 206 829.2

(51) Int. Cl. G06V 10/77; G06N 3/0464; G06N 3/08; G06V 10/82; G06V 10/98

(52) U.S. Cl. CPC G06V 10/7715; G06N 3/0464; G06N 3/08; G06V 10/82; G06V 10/993

(57) ABSTRACT

A method for optimizing activation maps, in particular for generating an optimized saliency map, includes (i) providing an activation or feature map which can be generated based on image data by a neural network, particularly a convolutional neural network, for each layer of the neural network and which indicates activation of channels of the neural network in response to the image data, (ii) at least for a plurality of pixels of the activation or feature map, determining pixel-by-pixel whether a quantile determinable across all channels is greater than a predetermined deviation function, or whether a magnitude across different quantiles is greater than a predetermined threshold value, in order to detect such an artifact the activation or feature map, and (iii) when an artifact is detected in the activation or feature map, applying a mitigation strategy to eliminate or at least reduce the detected artifact to provide an optimized activation or feature map.

This application claims priority under 35 U.S.C. § 119 to application no. DE 10 2024 206 829.2, filed on Jul. 19, 2024 in Germany, the disclosure of which is incorporated herein by reference in its entirety.

The disclosure relates to a method for optimizing activation maps, in particular for generating an optimized saliency map. The disclosure relates to a device for optimizing activation maps, in particular for generating an optimized saliency map.

### BACKGROUND

Saliency maps, also known as “explainability heat maps”, are a tool for visualizing the regions within an image relevant to predicting an image classification model. These maps highlight the areas that the model considers particularly important during the decision-making process. However, despite high classification metrics such as accuracy in the test set, the resulting model weights may have features that present challenges for calculating layer-based attribution methods such as Grad-CAM and its variations. Such features often manifest as artifacts in the saliency maps, which may impair the interpretability of the model decisions.

An example of such an artifact is shown in FIG. 1, where a large attribute value SDT 100 (artifact) can be seen in the upper left corner of the saliency map SDT102. This attribution value SDT 100 suggests that this position is relevant to the classification decision of the model, although it does not, in fact, contain any relevant information. In contrast, the less pronounced heat map assignments correspond to the actual defect positions in the image.

One reason for the occurrence of such artifacts is the sparseness of the feature maps in the later layers of neural networks that are critical for Grad-CAM-based explainability techniques. This sparseness means that only a few channels contribute positively to the decision, as shown in FIG. 2. In the diagram of FIG. 2, the number of channels is plotted on the Y axis and the activation value for a selected position (pixel) of an activation map is plotted on the X axis. FIG. 2 shows normal, sparse channel activations. In some cases, certain models or images do not show such sparseness as shown in FIG. 3, which can result in heat maps with artifacts. In the diagram of FIG. 3, the number of channels is plotted on the Y axis and the activation value for a selected position (pixel) of an activation map is plotted on the X axis. FIG. 3 shows non-sparse channel activations.

Thus, despite their utility in model interpretation, saliency maps are prone to artifacts that may distort the actual relevance of the highlighted image regions. Therefore, it is important to recognize these artifacts and consider them in the analysis and interpretation of the model decisions.

It is an object of the disclosure to provide an improved method and/or device in this respect.

The problem is solved by a method according to the features set forth below. The problem is solved by an apparatus according to the features set forth below.

### SUMMARY

According to a first aspect, a method for optimizing activation maps, in particular for generating an optimized saliency map, is proposed. The method comprises the steps of:
providing an activation or feature map which can be generated based on image data by a neural network, particularly a convolutional neural network (CNN), for each layer of the neural network and which indicates activation of channels of the neural network in response to the image data;
at least for a plurality of pixels of the activation or feature map, determining pixel-by-pixel whether a quantile determinable across all channels is greater than a predetermined deviation function, or whether a magnitude across different quantiles is greater than a predetermined threshold value, in order to detect such an artifact in the activation or feature map;
when an artifact is detected in the activation or feature map, applying a mitigation strategy to eliminate or at least reduce the detected artifact to provide an optimized activation or feature map; and
preferably generating an optimized saliency map based on the optimized activation or feature map.

It is understood that the steps according to the disclosure and further optional steps do not necessarily have to be carried out in the order shown, but may also be carried out in a different order. Furthermore, intermediate steps may also be provided. The individual steps may also comprise one or more sub-steps without going beyond the scope of the method according to the disclosure.

According to a second aspect, a device for optimizing activation maps, in particular for generating an optimized saliency map, is proposed. The device comprises an evaluation and/or computing device that is configured to perform the following steps:
providing an activation or feature map which can be generated based on image data by a neural network, particularly a convolutional neural network (CNN), for each layer of the neural network and which indicates activation of channels of the neural network in response to the image data;
at least for a plurality of pixels of the activation or feature map, determining pixel-by-pixel whether a quantile determinable across all channels is greater than a predetermined deviation function, or whether a magnitude across different quantiles is greater than a predetermined threshold value, in order to detect such an artifact in the activation or feature map;
when an artifact is detected in the activation or feature map, applying a mitigation strategy to eliminate or at least reduce the detected artifact to provide an optimized activation or feature map; and
preferably generating an optimized saliency map based on the optimized activation or feature map.
   The explanations given for the method apply to the apparatus accordingly. In this regard, any linguistic modifications of features formulated in terms of the method can be reformulated for the device in accordance with standard linguistic practice, without such formulations having to be explicitly listed here.

In the present case, a method and a device are proposed that aim to eliminate or at least minimize artifacts in saliency maps. In particular, the focus is on eliminating such artifacts that are not exclusively on attention levels, and which are particularly focused on plane mapping approaches such as Grad-CAM and its modifications.

The proposed method may serve as a processing stage for the attribution method. It detects and, if necessary, changes the activation maps prior to the creation of the saliency map, for example, by the Grad-CAM algorithm or one of its variants (such as HiResCAM, Grad-CAM++, etc.). Thus, artifacts are either eliminated or at least reduced so that users can examine the saliency maps without distraction by artifacts. This increases the accuracy of the results determined based on such edited saliency maps.

The method can be used in the context of automated optical inspection (AOI), in which AOI model developers want to check whether the trained machine learning model focuses on the practically relevant image areas in its classification decision.

The method is particularly applicable to images or video data captured, for example, during a manufacturing process by an optical sensor, for example, a camera, to determine whether a part is acceptable or not.

The method suggests identifying the spatial positions (i.e., pixels or pixel-by-pixel) in the plane selected for calculating a saliency-based heat map (also known as saliency maps) in which the channel activations are not sparse. Pixels detected in this manner indicate artifacts. To remove them and reduce their contribution to the saliency-based heat map, the artifacts are removed or at least minimized.

In manufacturing, automated optical inspection systems (AOI) are often used to detect potential errors after a particular phase of production. Given the high costs associated with ineffective AOI models, it is critical for manufacturing experts that these models function accurately to avoid, in particular, good component (OK) rejects that have been incorrectly identified by the AOI model as faulty (NOK). In addition to rating performance against performance metrics such as accuracy, users often want to review the saliency maps that highlight the specific areas of an image that are relevant to predicting the model. However, these saliency maps may sometimes contain artifacts that cover the image areas that are actually important for the classification accuracy of the model. Such artifacts may be eliminated or at least reduced by the present method.

A saliency map is a visual tool used in image processing and machine learning to highlight the most prominent or important parts of an image. These maps show which areas of an image attract the most attention, based on certain features such as brightness, color, contrast, or movement. In computer vision, the saliency maps are used for object detection and tracking by highlighting areas that are important to the task. Further, they are used to explain model decisions by showing what parts of an image were important for the classification or other decisions. For example, saliency maps are represented as gray-scale images, wherein brighter areas indicate higher saliency (i.e., greater prominence) and darker areas indicate lower saliency. They can also be colored to make the differences even more clear.

A quantile is a statistical measure that divides a distribution into equally sized, successive sections. Quantiles are particularly useful for analyzing and understanding the location and scattering of data.

A magnitude refers to a size or an amount of a physical quantity.

An activation or feature map is a visual representation that shows the activation of neurons in the various layers of a CNN when the network processes a particular image. These maps are generated by propagating the input data (in this case, image data) through the neural network and recording the activation patterns (the output) in each layer.

A CNN is a specific type of neural network that is particularly well-suited for processing image data because it can recognize spatial hierarchies and patterns in the data. CNNs are composed of multiple layers, including convolutional layers, pooling layers, and fully connected layers that extract progressively more complex features from the input data.

Activation maps can be created for each layer of the network, from the lower layers that detect simple features such as edges or textures to the higher layers that detect more complex features such as shapes or objects. These maps show how much each filter or neuron activation in the respective layer reacts to certain image regions.

Each channel in a layer of a CNN corresponds to a specific filter that detects certain features in the image. The activation maps show which channels (filters) have been activated at what strength when the network processes a particular image, and thus provide insight into the internal mechanisms and decision-making processes of the network. In summary, this feature describes the ability of a CNN to generate detailed maps that visualize the responses of the various network channels to image data. This is important for understanding and interpreting how the network functions, particularly in image processing and pattern recognition applications.

Artifacts in an activation map are undesirable or erroneous features that do not represent actual information about the input data, but rather are created by the neural network itself or by the process of map calculation. These artifacts may take different forms and have different causes. For example, noise is irregular or random activations that do not represent meaningful patterns. This may be due to random variations in the data or errors in the network. Grid patterns are regular, repetitive patterns that may arise due to the structure of the convolutional layers, especially if the filters are not properly trained or if the data has not been pre-processed well.

Overfitting effects, which occur when the network is too tuned to the training data, may cause the activation maps to show features that are specific to the training set but not generally relevant. Boundary effects occur at the edges of the activation maps, particularly when filters are applied to areas partially outside the image boundaries. Interpolation effects occur when the maps are enlarged or interpolated to make them more visible. This may result in distortions and artifacts that do not reflect the actual activations. Numerical instabilities are errors that may be created due to the limited accuracy of numerical calculations in the algorithms. These instabilities may result in inaccurate activation patterns.

In a further aspect, it is proposed that the quantile determinable across all channels has a percentile related to a respective pixel and a respective pixel position, in particular selected between 60 and 80, in particular preferably a 75th percentile.

It is assumed that a feature map of a layer of the neural network selected for the layer feature method is designated A. Further, it is assumed that a shape of the feature map is A (n_{channel}, height, width), with n_{channel} as the number of channels. It is proposed that a check is carried out for each pixel position (x, y), i.e., pixel by pixel, with 0≤x≤width and 0≤y≤height to determine whether a selectable quantile Q is greater than the deviation function.

In a further aspect, it is proposed that the deviation function comprises a sum of a mean deviation and a pre-factorized standard deviation, wherein the pre-factor of the standard deviation is preferably 2.

The deviation function is preferably defined as μ′+k σ′, wherein μ′ is the mean deviation across all dimensions (n_{channel}, height, width), k is the pre-factor, and ′ is the standard deviation across all dimensions (n_{channel}, height, width). k is preferably selected as 2.

To detect an artifact in the feature map, the following must be true in the area (pixels) being checked: Q>μ′+k σ′ (equation 1).

Particularly preferably, the following is checked: Q_{0.75}>μ′+k σ′, wherein Q_{0.75} is the 75 percentile via n_{channel} for a selected position of the feature map x, y.

In another aspect, it is proposed that the magnitude has a quotient of an X percentile and a Y percentile according to amount over different quantiles, wherein: X>Y, preferably wherein:

$$X = 75 and Y = 50 .$$

Alternatively, the magnitude or size of different quantiles can be compared, e.g.:

$$\frac{{Q}_{0.75}}{\vert {Q}_{0.5} \vert} > θ , \qquad ( equation 20 )$$

wherein θ is a certain threshold or threshold value.

In a further aspect, it is proposed that the mitigation strategy comprises a squishing of the respective channel activation values through a transformation, wherein, through the transformation, the activation values are distributed or compressed across the respective channel, wherein the value range for channel activation values is retained, or wherein the mitigation strategy comprises a trimming of the channel activation values.

In the present case, if the condition of equation 1 or equation 2 is assessed as “true”, a problematic pixel is identified in the present case so that a mitigation strategy can be applied. For these attenuation strategies, the channel activation values can be reduced by a transformation that ensures that the activation values are distributed across the channel while maintaining the value range, e.g., by using the following transformation:

$$\frac{{a}^{n}}{{max ( a )}^{n - 1}}$$

wherein a=A[:, x, y] is the feature map at a particular pixel position, and preferably wherein: n≥2, for example n=4.

Alternatively, the channel activation values can be clipped or trimmed, e.g., to the second largest value max([:,x′,y′]), wherein (x′,y′)≠(x,y) applies, i.e. only one of the pixel coordinates has to deviate.

The transformation mentioned above:

$$\frac{{m}^{n}}{{max ( m )}^{n - 1}}$$

can also be used as a post-processing transformation for saliency maps if only positive values are visualized. In this case, m is the positive heat map of the layer feature method. This may refine the saliency maps, which may widen by the upsampling method commonly used for layer feature methods.

In another aspect, it is proposed that the optimized saliency map be generated by a Grad-CAM based method.

Grad-CAM stands for gradient-weighted class activation mapping. It is a technique used to visualize which regions of an image contribute to a particular decision of a deep learning model. By using gradient information, Grad-CAM can highlight the decision-relevant areas in the image.

In a further aspect, a method for optimizing an automatic optical inspection (AOI) of a component is proposed. The AOI is preferably carried out using a machine learning model trained for this purpose. Based on the optimized saliency map generated in the present case, an inspection result generated by the trained machine learning model may be verifiable to, for example, verify the accuracy or inaccuracy of an inspection result generated by the model to retrain and/or optimize the model as appropriate.

Falsification of the inspection result, which may otherwise be caused by artifacts, can be eliminated or at least reduced by the optimized saliency map. The result is an improvement in the accuracy of the AOI, which is associated with reducing unnecessary waste from faulty inspection results.

In a further aspect, a control unit is also disclosed which is comprised in a robotic system and/or an industrial machine, and on which the present method is executable in one of its aspects.

In a further aspect, a computer program comprising program code is disclosed for executing at least parts of the present method in one aspect thereof when the computer program is executed on a computer. In other words, the computer program (product) comprises commands that, when the program is executed by a computer, cause the computer to perform the steps of the method in one of its embodiments.

In a further aspect, a computer readable data carrier comprising program code of a computer program is proposed for executing at least parts of the present method in one of its aspects when the computer program is executed on a computer. In other words, the disclosure relates to a computer-readable (storage) medium comprising commands which, when executed by a computer, cause the computer to execute the method/steps of the method in one of its aspects.

The described embodiments and refinements may be combined with one another as desired.

Further possible designs, refinements and implementations of the disclosure also comprise combinations of features of the disclosure described previously or below with regard to the exemplary embodiments that are not explicitly mentioned.

### BRIEF DESCRIPTION OF THE DRAWINGS

The accompanying drawings are intended to provide a better understanding of the embodiments of the disclosure. They illustrate embodiments and, in connection with the description, serve to explain principles and concepts of the disclosure.

Other embodiments and many of the advantages mentioned are shown in the drawings. The illustrated elements of the drawings are not necessarily shown to scale with respect to one another.

FIGS. 1-3 represent the prior art and will not be further discussed herein.

FIG. 4 shows a schematic flowchart of an exemplary embodiment of the present method.

FIG. 5 shows an exemplary saliency map with reduced artifacts.

In the figures of the drawings, identical reference numbers denote identical or functionally identical elements, parts or components, unless stated otherwise.

### DETAILED DESCRIPTION

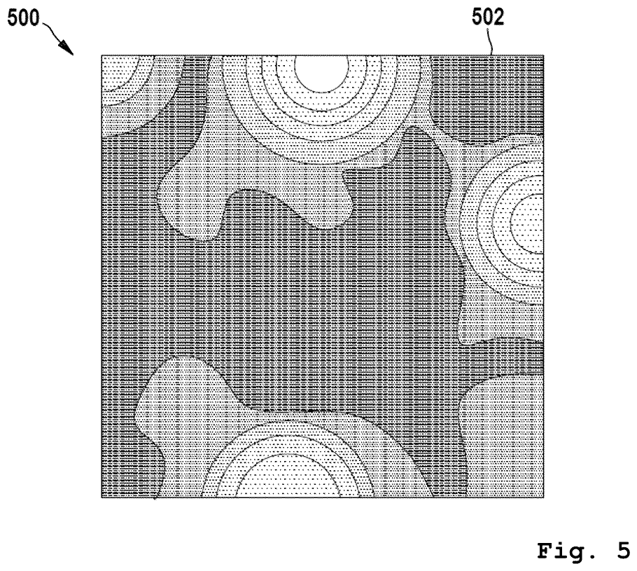

FIG. 4 shows a schematic flowchart of a method for optimizing activation maps, in particular for generating an optimized saliency map.

The method can be carried out in any embodiment, at least in part, by an apparatus 100 which may comprise several components not shown in detail, for example one or more provision devices and/or at least one evaluation-and-calculation unit. It is understood that the provision device may be configured so as together with the evaluation-and-calculation unit or may be different from it. Furthermore, the device 100, which may be part of a system, may comprise a storage device and/or an output device and/or a display device and/or an input device.

The computer-implemented method comprises at least the following steps:

In a step S1, an activation or feature map generated based on image data by a neural network, particularly a convolutional neural network (CNN), for each layer of the neural network and which indicates activation of channels of the neural network in response to the image data is provided.
In a step S2, at least for a plurality of pixels of the activation or feature map, it is determined pixel-by-pixel whether a quantile determinable across all channels is greater than a predetermined deviation function, or whether a magnitude across different quantiles is greater than a predetermined threshold value, in order to detect such an artifact in the activation or feature map.
In a step S3, when an artifact is detected in the activation or feature map, a mitigation strategy is applied to eliminate or at least reduce the detected artifact to provide an optimized activation or feature map.
In a step S4, preferably an optimized saliency map is generated based on the optimized activation or feature map.

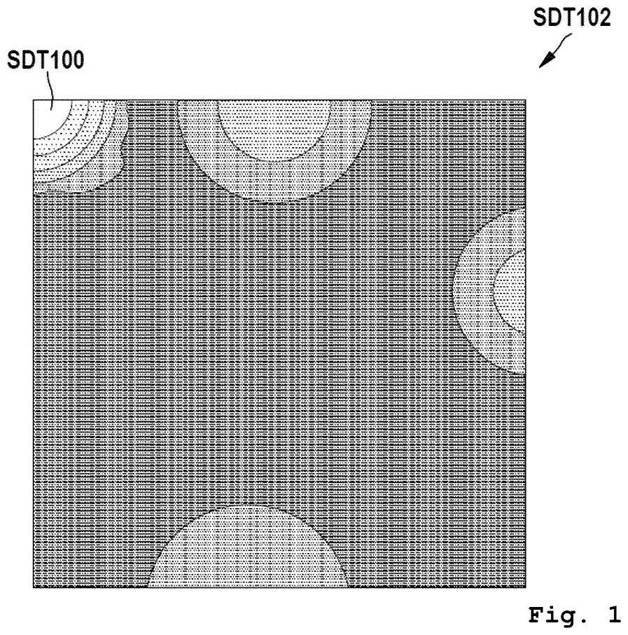

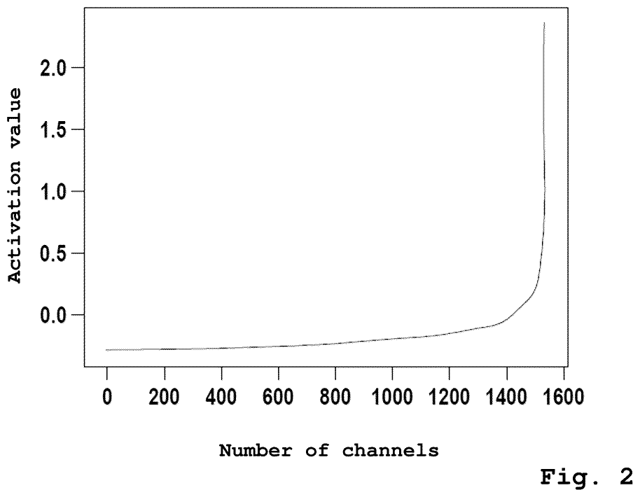

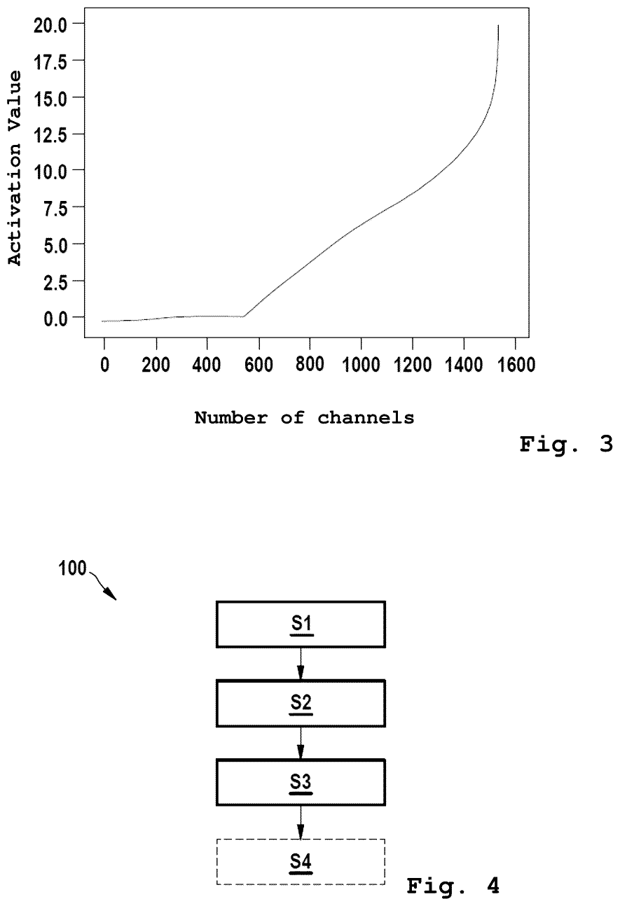

FIG. 5 shows a saliency map 500 with reduced artifact in the upper left corner of the image. The reduction can be seen in particular in conjunction with FIG. 1 from the prior art, in which there were artifacts in the upper left corner. FIG. 5 shows the saliency map 500 obtained by applying the above procedure and attenuation strategy through transformation. It can be seen that the effect of the artifact 502 is reduced in the upper left of the saliency map 500.

What is claimed is:

1. A method for generating an optimized saliency map, comprising:
providing an activation or feature map which can be generated based on image data by a convolutional neural network for each layer of the neural network and which indicates activation of channels of the neural network in response to the image data;
at least for a plurality of pixels of the activation or feature map, determining pixel-by-pixel whether a quantile determinable across all channels is greater than a predetermined deviation function, or whether a magnitude across different quantiles is greater than a predetermined threshold value, in order to detect such an artifact in the activation or feature map;
when an artifact is detected in the activation or feature map, applying a mitigation strategy to eliminate or at least reduce the detected artifact to provide an optimized activation or feature map; and
generating the optimized saliency map based on the optimized activation or feature map.

2. A method according to claim 1, wherein the quantile, which can be determined via all channels, comprises a percentile related to a respective pixel and a respective pixel position selected between 60 and 80.

3. A method according to claim 1, wherein the deviation function comprises a sum of a mean deviation and a pre-factorized standard deviation, wherein the pre-factor of the standard deviation is preferably 2.

4. The method according to claim 1, wherein the magnitude comprises a quotient of an X percentile and an amount Y percentile over various quantiles, wherein: X>Y.

5. A method according to claim 1, wherein the mitigation strategy comprises a squishing of the respective channel activation values by a transformation, wherein, by the transformation, the activation values can be distributed over the respective channel, wherein the value range of channel activation values is retained, or wherein the mitigation strategy comprises a trimming of the channel activation values.

6. The method according to claim 1, wherein the optimized saliency map is generatable by a Grad-CAM-based method.

7. A method for optimizing an automatic optical inspection of a component that is carried out using a machine learning model for this purpose, wherein an inspection result that can be generated by the trained machine learning model is verifiable based on the optimized saliency map that can be generated according to claim 1, wherein a distortion of the inspection result by the artifacts is at least reduced by the optimized saliency map.

8. A computer program having program code to execute at least portions of a method according to claim 1 when the computer program is executed on a computer.

9. A computer-readable data carrier having program code of a computer program to execute at least portions of a method according to claim 1 when the computer program is executed on a computer.

10. A device for generating an optimized saliency map, wherein the device comprising an evaluation and calculation means is configured to perform the following steps:
providing an activation or feature map which can be generated based on image data by a convolutional neural network for each layer of the neural network and which indicates activation of channels of the neural network in response to the image data;
at least for a plurality of pixels of the activation or feature map, determining pixel-by-pixel whether a quantile determinable across all channels is greater than a predetermined deviation function, or whether a magnitude across different quantiles is greater than a predetermined threshold value, in order to detect such an artifact in the activation or feature map;
when an artifact is detected in the activation or feature map, applying a mitigation strategy to eliminate or at least reduce the detected artifact to provide an optimized activation or feature map; and
generating an optimized saliency map based on the optimized activation or feature map.

11. A method for optimizing activation maps, comprising:
providing an activation or feature map which can be generated based on image data by a neural network for each layer of the neural network and which indicates activation of channels of the neural network in response to the image data;
at least for a plurality of pixels of the activation or feature map, determining pixel-by-pixel whether a quantile determinable across all channels is greater than a predetermined deviation function, or whether a magnitude across different quantiles is greater than a predetermined threshold value, in order to detect such an artifact in the activation or feature map; and
when an artifact is detected in the activation or feature map, applying a mitigation strategy to eliminate or at least reduce the detected artifact to provide an optimized activation or feature map.

12. The method according to claim 1, wherein the magnitude comprises a quotient of an X percentile and an amount Y percentile over various quantiles, wherein: X=75 and Y=50.
